(19) United States
(12) Patent Application Publication
(10) Pub. No.: US 2006/0174155 A1
(43) Pub. Date: Aug. 3, 2006

(54) System, method and computer program product for testing software

(75) Inventor: David Hennah Mansell, Usk (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cherry Hinton (GB)

(21) Appl. No.: 11/049,284

(22) Filed: Feb. 3, 2005

(51) Int. Cl. G06F 11/00

(52) U.S. Cl. 714/5

(57) ABSTRACT

A system, method and computer program product are provided for testing software to be run on a data processing apparatus having a processor for performing data processing operations, a memory for storing data for access by the processor, and at least one temporary storage located between the processor and the memory and operable to temporarily store data to improve speed of access to that data by the processor. The software tested controls the maintenance of data by the at least one temporary storage. The test system comprises a processor simulator for simulating the data processing operations performed by the processor, including issuing an access request when access to a data value is required, the access request causing one or more data access operations to be performed. The test system also includes a temporary storage simulator provided for each temporary storage, and arranged to simulate the operation of that associated temporary storage. Each data access operation of the access request is routed to an appropriate temporary storage simulator, and that temporary storage simulator then determines whether the data required by that data access operation is stored in the temporary storage simulator. If so, the required data is retrieved from the temporary storage simulator rather than from memory. The test system also includes a checker operable to perform a checking operation to check the accuracy of the data retrieved for each data access operation of the access request.

### BACKGROUND OF THE INVENTION

1. Field of the Invention

The present invention relates to a system, method and computer program product for testing software.

2. Description of the Prior Art

When developing software to run on a data processing apparatus, it is known to model the elements of the data processing apparatus as a software model, and then to run the software under development on that software model in order to test the operation of the software. Such an approach is often used where the software and hardware are being developed in parallel, and the software developers do not wish to wait until the hardware is finalised before being able to test the software being developed. By allowing testing of the software on the software model, certain potential problems with the software can be detected earlier than would otherwise be possible.

A processor will typically access memory via one or more intermediate temporary storage devices used to store data so that it is accessible more quickly than would be the case if that data was accessed directly in memory. Hence, as an example a cache may be provided for storing data values (either instructions to be executed on the processor or data to be processed by the processor when executing such instructions). If a data value the subject of an access request is present in the cache, it will be accessed in the cache rather than in memory, and only if the data value is not in the cache will the access request be propagated on to memory to cause the required data value to be accessed in memory. As will be appreciated by those skilled in the art, the cache may be a unified cache for storing instructions and data, or may take the form of separate instruction and data caches.

A data processing apparatus will also typically include a Memory Management Unit (MMU) operable, upon receipt of an access request issued by the processor when the processor wishes to access a data value, to perform one or more predetermined access control functions to control issuance of that access request to the memory system. As an example, such predetermined access control functions could involve translation of virtual addresses to physical addresses, review of access permissions rights to ensure that the processor in its current mode of operation is entitled to access the data value requested, analysis of region attributes, for example to determine whether the data value is cacheable, bufferable, etc.

To enable the MMU to perform these functions one or more page tables will be defined in memory, each page table containing descriptors which, for particular address ranges, provide associated access control information to be used by the MMU. A translation lookaside buffer is often provided in the MMU for storing this access control information retrieved when accessing page table descriptors in memory so that for a subsequent access request this information is more quickly available to the MMU. Hence, such a TLB is another example of an intermediate temporary storage device provided within a data processing apparatus to improve speed of access to data.

Within a software model of a data processing apparatus, the function of a processor can be modelled using a processor simulator, the processor simulator being designed to replicate the function of a particular processor. Further, the intermediate temporary storage devices may also be modelled by temporary storage simulators designed to simulate the operation of that associated temporary storage device.

Some software that may be tested on such a software model will include, as one of its functions, the maintenance of data by one or more of the temporary storage devices, and hence may be responsible for cleaning and/or invalidating entries in those temporary storage devices when necessary. It is important that these functions are performed as required to ensure that when the processor issues an access request, it does not access out-of-date data, also referred to herein as “stale” data.

As an example, if the processor modifies a particular instruction, it may output that modified instruction as a data value for storage in memory. This modified data value may be temporarily stored in the data cache, and may not necessarily at that time be returned to memory. If when the processor subsequently issues an access request for that instruction, the instruction cache holds an out-of-date entry for that instruction, the processor will be provided with a stale instruction. This would also occur if the instruction cache did not have an entry for the instruction in question, but the software maintaining the temporary storage devices did not ensure that the relevant entry in the data cache was flushed to memory before the instruction was retrieved from memory by the instruction cache.

As another example, considering the page table used by the MMU, if the processor updates a page table, this updated data will again typically be stored to memory via the data cache. If the TLB holds out-of-date access control information, this may cause the incorrect virtual to physical address translation to be performed in the MMU when processing an access request, which may result in an incorrect data value altogether being accessed. Further, other checks performed by the MMU may produce incorrect results, for example a processor may be permitted access to an area of memory when the updated page table data would have prevented such access, etc.

With regards to data values temporarily stored in a data cache, errors in data values retrieved may occur in situations where the data cache is virtually indexed and/or addressed.

However, if the software is not performing the required maintenance functions as intended, it can be difficult to track down the source of any resulting errors. This problem becomes even more difficult in multi-processing systems such as a Symmetric Multi-Processing (SMP) system in which multiple processors share memory. Within such an SMP data processing apparatus, the multiple processors will need to co-operate to ensure that all stale data is flushed from the various associated intermediate temporary storage devices, and the source of resulting errors is even more difficult to track down.

It would hence be desirable to provide a technique for testing software which more readily enabled the source of such errors to be identified.

### SUMMARY OF THE INVENTION

Viewed from a first aspect, the present invention provides a test system for testing software to be run on a data processing apparatus having a processor operable to perform data processing operations, a memory operable to store data for access by the processor, and at least one temporary storage located between the processor and the memory and operable to temporarily store data to improve speed of access to that data by the processor, the software being operable to control the maintenance of data by the at least one temporary storage, the test system comprising: a processor simulator operable to simulate the data processing operations performed by the processor, the processor simulator being operable to issue an access request when access to a data value is required, the access request causing one or more data access operations to be performed; a temporary storage simulator provided for each temporary storage and operable to simulate the operation of that associated temporary storage, each data access operation of the access request being routed to an appropriate temporary storage simulator, and that temporary storage simulator being operable in response to the data access operation to determine whether data required by that data access operation is stored in the temporary storage simulator, and if so to cause that data to be retrieved from the temporary storage simulator rather than from the memory; and a checker operable to perform a checking operation to check the accuracy of the data retrieved for each data access operation of the access request.

In accordance with the present invention, each data access operation of an access request is routed to an appropriate temporary storage simulator provided within the test system, with that temporary storage simulator being arranged to determine whether data required by that data access operation is stored in the temporary storage simulator. If so, that data is retrieved from the temporary storage simulator rather than from memory. In the context of the test system, it will be appreciated that the term “memory” actually refers to a simulation of the memory to be provided in the data processing apparatus modelled by the test system. Since it is possible that data provided from the temporary storage simulator in such a way may be stale, the test system of the present invention further provides a checker which is operable to perform a checking operation to check the accuracy of the data retrieved for each data access operation of the access request. If there is any discrepancy, then a record of that discrepancy can be made so as to allow later analysis of that discrepancy information by a user of the test system. In one embodiment, the test system is allowed to continue its operation even after such a discrepancy has been determined by the checker, and a log of such discrepancies is merely retained for future analysis. However, in an alternative embodiment, the test system could be arranged in some situations to stall its operation upon detection of any such discrepancy.

The checker may perform the checking operation in a variety of ways. In one embodiment, for each data access operation, the checker may be arranged to access memory and any temporary storage simulator (for example a data cache simulator) in which a version of the data required by that data access operation may be stored, in order to check whether any more up-to-date version of that data exists than the version stored in the temporary storage simulator responding to that data access operation. Wherever the version of the data retrieved from that temporary storage simulator is established to be out-of-date, then the checker can generate appropriate discrepancy information.

However, in an alternative embodiment, the test system further comprises: a reference image of the memory; and a monitor operable, when the processor simulator outputs a write access request containing an updated data value, to cause that updated data value to be directly stored in the reference image, such that the reference image contains an up-to-date version of the data accessible by the processor simulator; the checker being operable to refer to the reference image of the memory when performing the checking operation. In accordance with this embodiment, a separate reference image of memory is maintained within the test system that is updated instantly on any write access request, bypassing any write buffers, caches, etc that may be present. The checker then merely needs to consult the reference image of memory when performing the checking operation in order to check the accuracy of the data retrieved for each data access operation of the access request. Since the test system is typically implemented as a software model, such a reference image of memory can be readily incorporated within the test system without affecting the test system's ability to accurately replicate the function of the data processing apparatus being modelled by the test system. The use of such a reference image of memory has been found to be a particularly efficient technique for enabling the checker to perform the required checking operation to check the accuracy of data retrieved for each data access operation of an access request.

In one particular embodiment, each data access operation specifies an address, and the checker is operable to determine whether the data retrieved for that data access operation corresponds to the data as stored at that address in the reference image of the memory, and if not to generate discrepancy data. This discrepancy data can be used to alert the user of the test system as to the presence of an error resulting from use of stale data.

In one embodiment, the test system further comprises a log into which any discrepancy data generated by the checker is stored. The user is hence provided with a complete record of discrepancy data which can be analysed at an appropriate point, either during testing, or following a particular test procedure.

The temporary storage modelled by the temporary storage simulator may take a variety of forms. In one embodiment, at least one temporary storage simulator in the test system is operable to simulate the operation of a data cache and is arranged to receive a data access operation performed for any access request issued by the processor simulator and pertaining to data processed by the processor simulator. In one embodiment, if that access request is a write access request, the monitor is operable to cause the updated data value to be stored in the reference image of memory without waiting for the updated data value to be stored in the memory. Hence, it can be seen that in such situations there is no delay in update to the reference image of memory resulting from any temporary caching of data in the data cache.

In one embodiment, at least one temporary storage simulator in the test system is operable to simulate the operation of an instruction cache and is arranged to receive a data access operation performed for any read access request issued by the processor simulator and pertaining to an instruction required for execution by the processor simulator. An instruction cache is typically used to temporarily store instructions retrieved from memory, so that they may be more readily accessed by an associated processor. If a new instruction is created by the processor, this is normally written to memory via a data cache as a block of data, and is then subsequently read into the instruction cache when a read access request for access to that instruction is subsequently issued by the processor. It will hence be appreciated that there is a possibility of the instruction cache containing stale instruction data, and such a situation can be detected by the checker of the test system of embodiments of the present invention.

In one embodiment, at least one temporary storage simulator in the test system is operable to simulate the operation of a translation lookaside buffer of a memory management unit, and is arranged to receive a data access operation specifying the virtual address of each access request issued by the processor simulator and to determine whether data required to generate a physical address from that virtual address is stored within the temporary storage simulator. In one particular embodiment, the data required to generate a physical address is located in a page table stored in the memory, and is retrievable from the memory into the translation lookaside buffer if necessary to enable the physical address to be generated by the memory management unit; and the checker is operable to compare the physical address generated by the memory management unit with the physical address that would have been generated from the page table data stored in the reference image of the memory. Hence, again the checker can be used to provide a reliable check as to the accuracy of the data retrieved from the temporary storage simulator.

In some embodiments, the test system may be used to model a data processing apparatus having only a single processor. However, in alternative embodiments, the data processing apparatus has a plurality of processors, each processor having at least one temporary storage associated therewith, the test system comprising: one of said processor simulators for each of said plurality of processors; and for each processor simulator, a temporary storage simulator provided for each temporary storage associated with the corresponding processor. Hence, as an example, the test system may be used to test software to be run on an SMP data processing system. In such systems, multiple processors may have to co-operate to make sure all stale data is flushed from associated temporary storage devices, and this added complexity can increase the risk of errors resulting from use of out-of-date data occurring. Furthermore, the added complexity can increase the difficulty in identifying the source of such errors. Hence, in such systems, the provision of the checker within the test system to check the accuracy of data retrieved for each data access operation is particularly beneficial.

The software tested by the test system may take a variety of forms. However, in one embodiment, the software is operating system software, operating systems typically being responsible for maintaining caches, TLBs, and the like, and for cleaning and/or invalidating entries in such temporary storage devices when necessary. If the operating system is not performing these functions correctly, it can be difficult to track down the source of the resulting errors, and hence again the provision of a checker within the test system to check the accuracy of data retrieved for each data access operation provides discrepancy data that is very useful in tracking down such errors.

Viewed from a second aspect, the present invention provides a method of testing software to be run on a data processing apparatus having a processor for performing data processing operations, a memory for storing data for access by the processor, and at least one temporary storage located between the processor and the memory for temporarily storing data to improve speed of access to that data by the processor, the software being operable to control the maintenance of data by the at least one temporary storage, the method comprising the steps of: simulating the data processing operations performed by the processor, including issuing an access request when access to a data value is required, the access request causing one or more data access operations to be performed; simulating the operation of each temporary storage using an associated temporary storage simulator; providing each data access operation of the access request to an appropriate temporary storage simulator; in response to receipt of one of said data access operations by said appropriate temporary storage simulator, determining whether data required by that data access operation is stored in that temporary storage simulator, and if so retrieving that data from the temporary storage simulator rather than from the memory; and performing a checking operation to check the accuracy of the data retrieved for each data access operation of the access request.

Viewed from a third aspect, the present invention provides a computer program product carrying a computer program which when executed on a computer implements a method of testing software to be run on a data processing apparatus having a processor for performing data processing operations, a memory for storing data for access by the processor, and at least one temporary storage located between the processor and the memory for temporarily storing data to improve speed of access to that data by the processor, the software being operable to control the maintenance of data by the at least one temporary storage, the computer program implementing the steps of: simulating the data processing operations performed by the processor, including issuing an access request when access to a data value is required, the access request causing one or more data access operations to be performed; simulating the operation of each temporary storage using an associated temporary storage simulator; providing each data access operation of the access request to an appropriate temporary storage simulator; in response to receipt of one of said data access operations by said appropriate temporary storage simulator, determining whether data required by that data access operation is stored in that temporary storage simulator, and if so retrieving that data from the temporary storage simulator rather than from the memory; and performing a checking operation to check the accuracy of the data retrieved for each data access operation of the access request.

Viewed from a fourth aspect, the present invention provides a test system for testing software to be run on a data processing apparatus having a processor for performing data processing operations, a memory for storing data for access by the processor, and at least one temporary storage located between the processor and the memory for temporarily storing data to improve speed of access to that data by the processor, the software being operable to control the maintenance of data by the at least one temporary storage, the test system comprising: processor simulator means for simulating the data processing operations performed by the processor, the processor simulator means being arranged to issue an access request when access to a data value is required, the access request causing one or more data access operations to be performed; temporary storage simulator means provided for each temporary storage and for simulating the operation of that associated temporary storage, each data access operation of the access request being routed to an appropriate temporary storage simulator means, and that temporary storage simulator means being responsive to the data access operation to determine whether data required by that data access operation is stored in the temporary storage simulator means, and if so to cause that data to be retrieved from the temporary storage simulator means rather than from the memory; and checker means for performing a checking operation to check the accuracy of the data retrieved for each data access operation of the access request.

### BRIEF DESCRIPTION OF THE DRAWINGS

The present invention will be described further, by way of example only, with reference to embodiments thereof as illustrated in the accompanying drawings, in which:

FIG. 1 is a block diagram illustrating a test system in accordance with one embodiment of the present invention;

FIG. 2 is a block diagram illustrating in more detail the checker of FIG. 1;

FIG. 3 is a diagram schematically illustrating discrepancy data that may be stored in the discrepancy log of FIG. 2; and

FIGS. 4 to 6 are flow diagrams illustrating various data access operations that may be performed as part of an access request, along with associated checking procedures, in accordance with one embodiment of the present invention.

### DESCRIPTION OF EMBODIMENTS

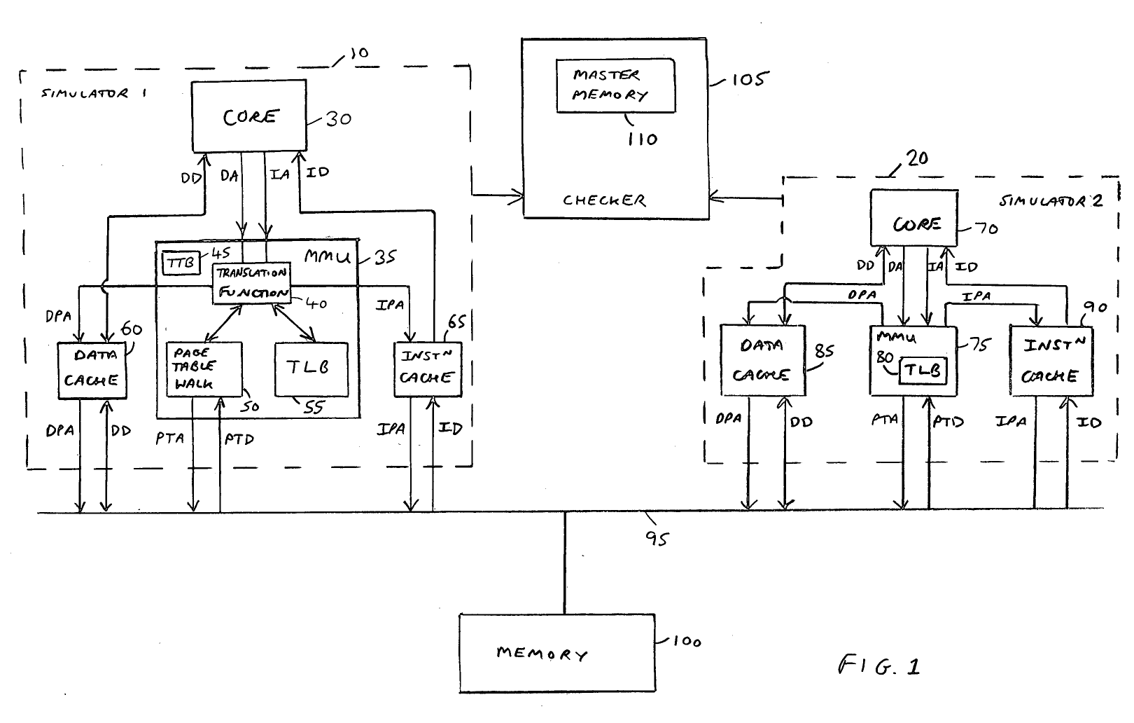

FIG. 1 is a block diagram schematically illustrating a test system (also referred to herein as a software model) used to replicate the function of an SMP data processing apparatus, such an SMP data processing apparatus having a plurality of processing units operable to share access to a memory system.

As shown in FIG. 1, the test system includes first and second simulators 10, 20. The first simulator 10 includes a core simulator 30 for simulating the operations of the processor core of the processing unit simulated by the simulator 10, a Memory Management Unit (MMU) simulator 35 for simulating the operations of an MMU provided within the processing unit being simulated, and data cache 60 and instruction cache 65 simulators for simulating the operations of a data cache and instruction cache, respectively, of the processing unit being simulated.

The second simulator 20 likewise includes a core simulator 70, an MMU simulator 75 and data cache 85 and instruction cache 90 simulators.

Each of the simulators 10, 20 are coupled via a bus 95 to memory 100. It will be appreciated that in the context of the test system the element 95 is actually a simulation of the bus of the data processing apparatus being modelled by the test system, and likewise the element 100 is actually a simulation of the memory to be provided in such a data processing apparatus. However, for simplicity, these elements will be referred to herein as the bus 95 and the memory 100.

Further, the test system includes a checker 105 which incorporates a master image 110 of the memory 100, this-master image of memory also being referred to herein as master memory or a reference image of memory. It should be noted that the checker 105 and master memory 110 are provided solely in the test system, and do not have any equivalent in the data processing apparatus being modelled by the test system.

Each of the MMU simulators 35, 75 have a similar structure, and in particular include translation lookaside buffers (TLBs) 55, 80. For simplicity in the figures, the detail of the MMU simulators 35, 75 has only been shown in relation to the MMU simulator 35 of the first simulator 10.

When the core simulator 30 requires access to a data value, it will issue an access request. If the access request pertains to data to be processed by the core simulator 30, then a data address (DA) will be issued to the MMU simulator 35. This data address will typically be in the form of a virtual address which will be translated into a physical address by the translation function 40 within the MMU simulator 35. As will be appreciated by those skilled in the art, an MMU will normally perform further access control functions in addition to virtual to physical address translation, such as review of access permission rights, analysis of region attributes, etc. Such functions will also be replicated by the MMU simulator 35, but for simplicity the functionality used to perform those other access control functions is omitted from the figures.

To enable the required access control procedures to be performed by the MMU simulator 35, one or more page tables will be defined in memory 100, each page table including a number of descriptors and each descriptor identifying, for a particular address range, associated access control information. If a particular descriptor needs to be accessed from memory 100, then the translation function 40 can initiate the access by accessing the translation table base (TTB) 45 to identify a base address for the relevant page table, and then using that information, along with the data address provided by the core simulator 30, to instruct the page table walk function 50 to output a page table address (PTA) to the memory 100 in order to cause the required descriptor in the form of page table data (PTD) to be returned via the page table walk function 50 to the translation function 40. As page table descriptors are retrieved, they are temporarily stored in the TLB 55, so that if they are subsequently required again the translation function 40 can access that descriptor information without needing to again access the memory 100.

It will be appreciated that in some embodiments one page table walk may cause multiple memory accesses to be performed, for example when using two-level page tables.

Once the translation function 40 has performed the necessary virtual to physical address translation with respect to the relevant descriptor's access control information, then it outputs a data physical address (DPA) to the data cache simulator 60, which then uses that information to determine whether the data the subject of the access request is already stored in the data cache simulator 60. If so, then the data value (DD) the subject of the access request can then be returned to the core simulator 30 in the event of a read access request, or written into the data cache simulator 60 in the event of a write access request. If the data value in question relates to a write back region of memory, then the data cache simulator 60 will not typically output the data value for storage in memory 100 as soon as that data value is written into the data cache 60 from the core simulator 30, whereas if the data value relates to a write through region of memory, then the data cache simulator 60 will output that data value to memory 100 as soon as it is updated in the data cache simulator 60.

If a cache miss occurs in the data cache simulator 60, then the data physical address will be propagated via the bus 95 to memory 100, such that the data access is performed with respect to memory 100. It should be noted that a write buffer simulator (not shown in FIG. 1) may be located between the data cache simulator 60 and the bus 95 to model any write buffer provided at the corresponding point in the data processing apparatus being modelled.

The instruction cache simulator 65 works in a similar way to the data cache simulator 60, but it should be noted that the instruction cache simulator 65 only responds to read requests. In particular, if a new instruction is created by the core simulator 30, it will at that time be treated as data and routed via the data cache simulator 60 to memory 100.

When a read access request pertaining to an instruction is issued by the core simulator 30, then an instruction address (IA) will be issued to the MMU simulator 35, where the translation function 40 will then perform the required virtual to physical address translation using the earlier described techniques. This will result in the issuance of an instruction physical address (IPA) to the instruction cache simulator 65. If a hit then occurs in the instruction cache simulator 65, the instruction data (ID) will be returned directly to the core simulator 30 from the instruction cache simulator 65, whereas in the event of a cache miss, the instruction physical address (IPA) will be output on to the bus 95 to cause the instruction data to be retrieved from memory 100 into the instruction cache simulator 65, from where it is then provided to the core simulator 30.

The second simulator 20 operates in an analogous manner to that described above in relation to the first simulator 10.

In FIG. 1, the data cache simulators and instruction cache simulators model physically addressed caches. However, in an alternative embodiment, such simulators may model virtually addressed caches, in which event the virtual address (DA or IA) will be used to index the cache simulators and the physical address (DPA or IPA) will only be used in the event of a cache miss.

In accordance with embodiments of the present invention, at initiation time, the master memory 110 is arranged to store a complete copy of the data stored in the memory 100. Then, each time a write access request is issued by the core simulators 30, 70 of each simulator 10, 20, the data value the subject of that write access request is provided directly to the checker 105 where it is stored within the master memory 110, thus ensuring that the master memory 110 maintains an up-to-date version of all data. The updated data values are only committed to master memory 110 once it has been determined that the write access request can proceed, as discussed earlier this determination typically being made by the respective MMU simulator 35, 75.

By such an approach, it can be seen that the master memory 110 can be updated instantly on any write operation, bypassing write buffers, caches, etc that may be provided within the data processing apparatus, and hence modelled within the test system.

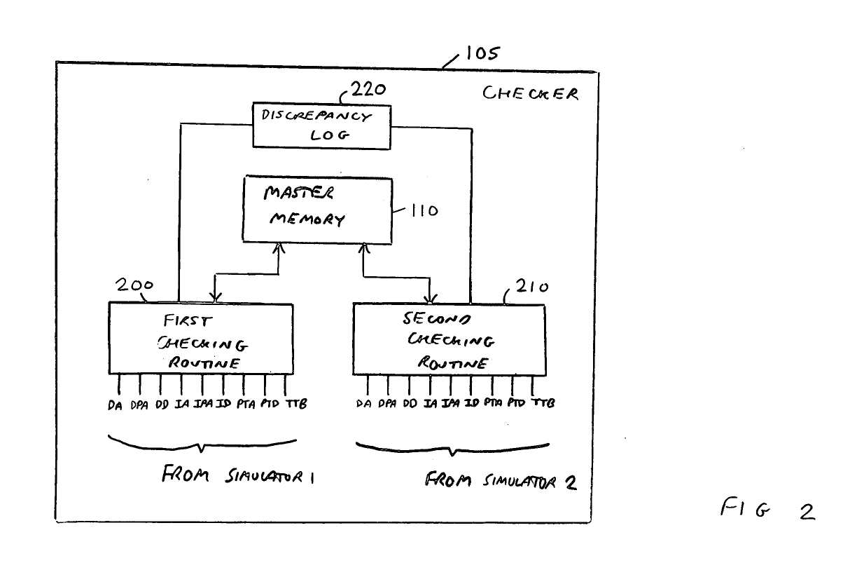

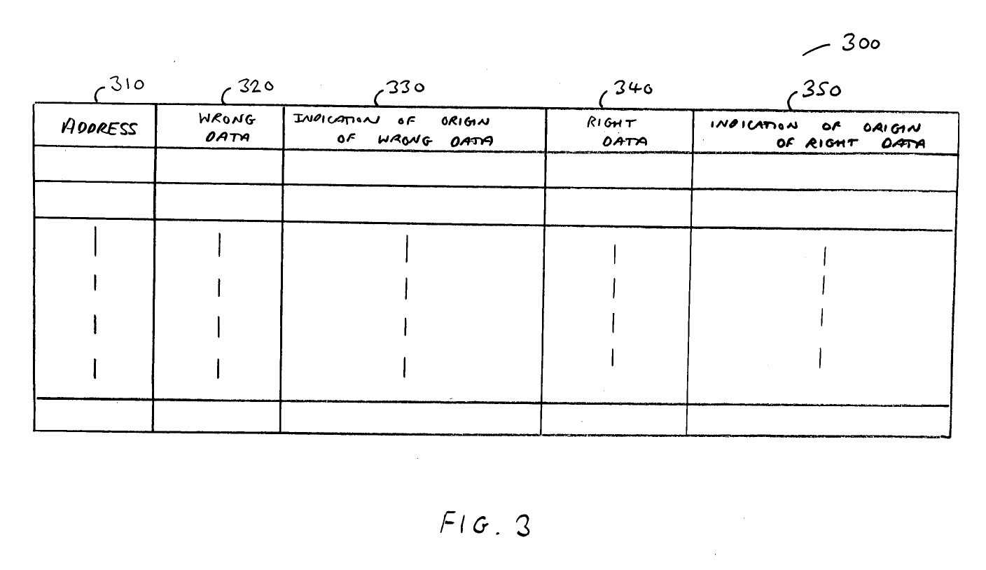

By employing such a system, the checker 105 can then perform a check for each data access operation of an access request to ensure that data accessed from any temporary storage simulator in the test system when handling such a data access operation is up-to-date. As is apparent from the example of FIG. 1, data may be retrieved from the data cache simulator 60, TLB 55 and instruction cache simulator 65 when performing various data access operations resulting from an access request issued by the core simulator 30. Similarly, considering the second simulator 20, data may be accessed from the data cache simulator 85, the TLB 80, or the instruction cache simulator 90 when processing data access operations of an access request issued by the core simulator 70. For each such data access operation, the data accessed can be checked by the checker 105 against the corresponding data found in the master memory 110 in order to determine whether there is a match. If there is a match, then this means that the data accessed from the temporary storage simulators is up-to-date. However, if there is any discrepancy, then this indicates that the data accessed from the relevant temporary storage simulator 60, 55, 65, 85, 80, 90 is out-of-date, and accordingly a discrepancy log can be produced to flag that discrepancy to a user of the test system. This will be discussed further with reference to FIGS. 2 and 3.

As shown in FIG. 2, the checker 105 incorporates first and second checking routines 200, 210 provided in respect of the first and second simulators 10, 20. Each checking routine is arranged to receive from its associated simulator any virtual addresses, physical addresses, data values and TTB values produced within the associated simulator so that it can then perform any required checks against data stored in the master memory 110. Hence, by way of example, each checking routine can determine whether any data values (ID or DD values) retrieved from temporary storage simulators match the corresponding values stored within the master memory 110. Further, each checking routine can use the virtual address and corresponding physical address produced within the simulators by their associated MMU simulators to determine whether the same correspondence between virtual and physical address would have been determined using the page table descriptor data (PTD) stored within the master memory 110. The other access control information of the page table descriptor can also be checked against the corresponding data stored in the master memory 110. In such checks, the TTB value is also used to ensure that the appropriate page table descriptor is referenced in the master memory 110.

Wherever any discrepancy is determined to exist, an entry is made in a discrepancy log 220, this discrepancy log being shown in more detail in FIG. 3.

FIG. 3 illustrates one example of the type of information that may be stored within each entry in the discrepancy log. In the example illustrated in FIG. 3, five pieces of information are stored in any entry, including the physical address 310 of the data for which a discrepancy was found. As discussed earlier, this data may be instruction data, data processed by a core simulator, or page table descriptor data used in performing access control functions. In addition to this address information 310, the wrong data 320 is stored (i.e. the data retrieved from the relevant temporary storage simulator), along with an indication 330 of the origin of that wrong data, for example an indication as to which temporary storage simulator produced that wrong data. Further, additional information is stored in the entry of the discrepancy logic identifying the right data 340 and an indication 350 of the origin of that right data, i.e. where the right data 340 in the master memory 110 was written from. Hence, in an SMP system, such an indication 350 may identify the processor that issued the right data.

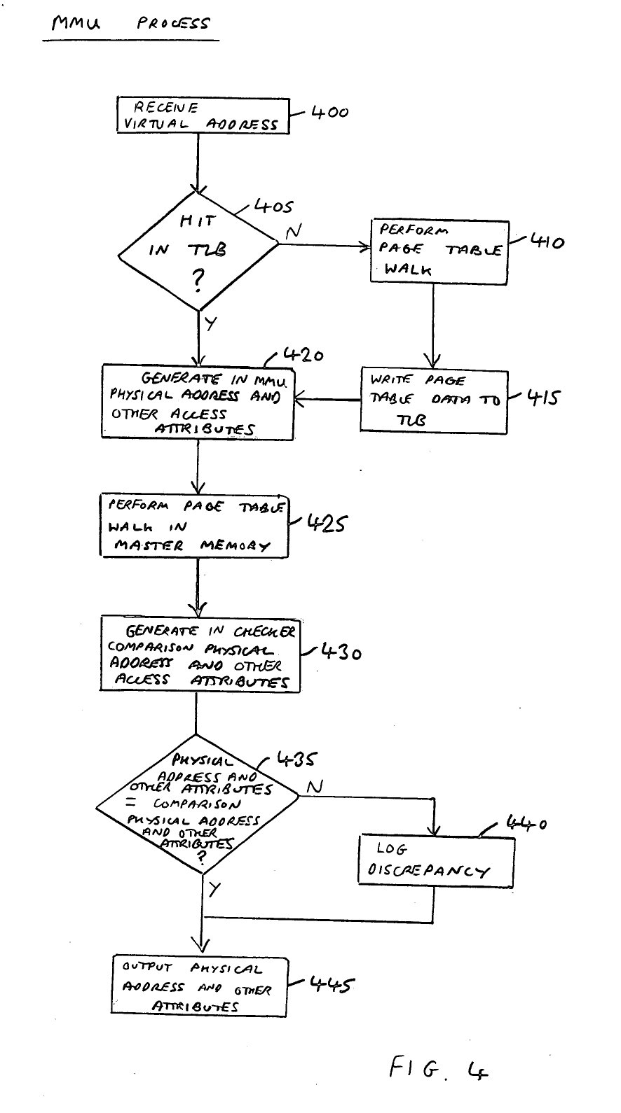

FIG. 4 is a flow diagram illustrating in more detail the process performed by each MMU simulator 35, 75 in accordance with one embodiment of the present invention, along with the associated checking process performed by the checker 105. At step 400, a virtual address (DA or IA) is received, whereafter at step 405 the MMU simulator determines whether there is a hit in the TLB of that MMU simulator. If not, then a page table walk process is performed at step 410 to access the required page table descriptor data from memory 100, whereafter that page table data is then written into the TLB at step 415.

Thereafter, at step 420 the MMU generates a physical address and any other access attributes required in association with the access request, for example identifying whether the associated data value is cacheable, bufferable, etc. It will be noted that the process will proceed directly from step 405 to 420 in the event that a hit is determined in the TLB, since in that event the required page table descriptor data will already be stored within the MMU simulator.

At step 425, a page table walk process is performed in the master memory 110 by the checker 105 in order to identify the relevant page table descriptor data as stored in the master memory. Thereafter, at step 430, the checker will use that information accessed in the master memory in order to generate a comparison physical address and other access attributes, which at step 435 are then compared with the physical address and other access attributes produced by the relevant MMU simulator at step 420, in order to determine whether there is a match. If there is a complete match between the physical address and other access attributes produced by the MMU simulator and the comparison physical address and other access attributes produced by the checker with reference to the master memory 110, then the physical address and other access attributes produced by the MMU simulator are merely output at step 445. However, if there is any discrepancy, then that discrepancy is logged at step 440 prior to the physical address and other access attributes generated by the MMU simulator being output at step 445.

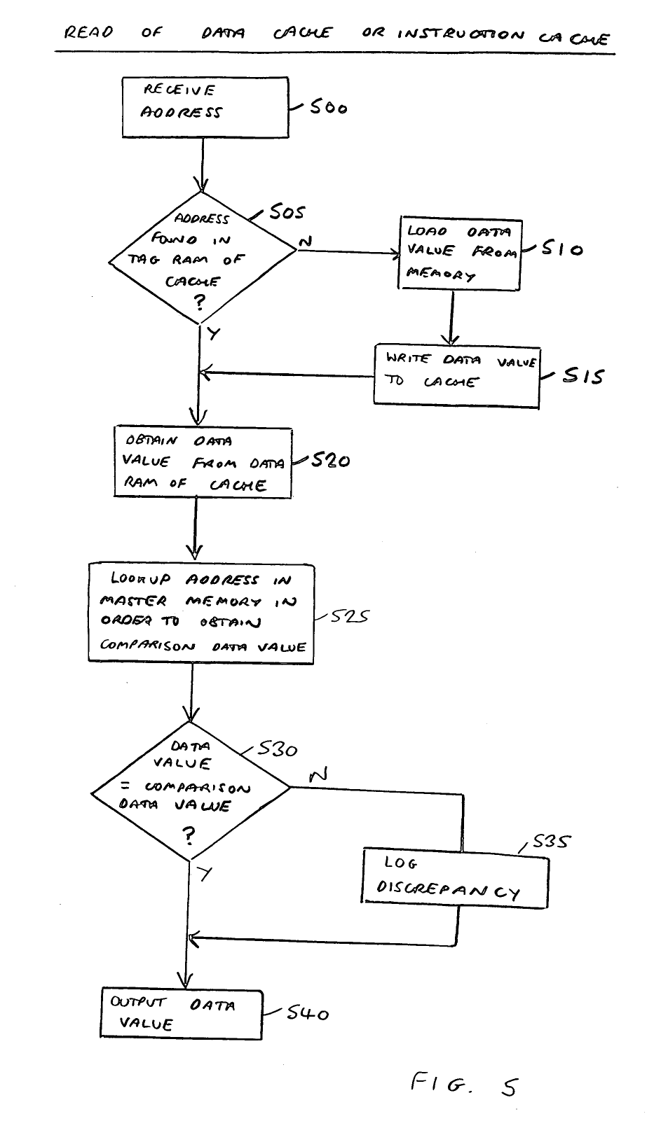

FIG. 5 is a flow diagram illustrating the process performed when reading a data value from either the data cache simulator or the instruction cache simulator of either the simulator 10 or the simulator 20, along with the associated checking procedure performed by the checker 105. At step 500, an address is received by the cache simulator, in the FIG. 1 embodiment this being a physical address. Thereafter, it is determined at step 505 whether that address is found in the tag RAM of the cache simulator (i.e. that part of the cache simulator used to hold the addresses associated with each of the data entries in the cache simulator) and if not this means that there is a cache miss. Accordingly, in the event of a cache miss, the required data value is loaded from memory at step 510, whereafter at step 515 that data value is written into the cache simulator. It will be appreciated by those skilled in the art that there are a variety of cache eviction policies that may be used in order to free up space in the cache simulator for the storage of any such data.

Following step 515, or directly following step 505 in the event of a cache hit, the required data value is obtained from the data RAM of the cache simulator at step 520. At step 525, the checker 105 is arranged to perform a lookup process in the master memory 110 in order to obtain a comparison data value found at the address received at step 500. Then, at step 530, the data value read from the cache simulator is compared with the comparison data value, and if they match the data value produced by the cache simulator is output at step 540. However, if they do not match, the discrepancy is logged at step 535, whereafter the data value read from the cache simulator is output at step 540.

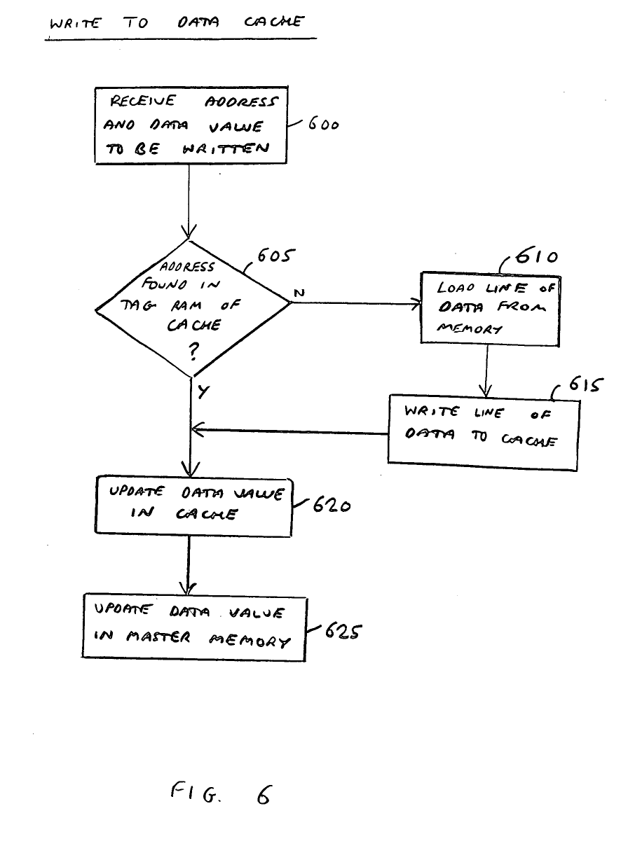

FIG. 6 is a flow diagram illustrating the process performed when performing a write access request to the data cache simulator 60, 85 of either simulator 10, 20. As mentioned previously, in the embodiment of FIG. 1 the instruction cache simulators are not arranged to receive write access requests. At step 600, the address and data value to be written are received by the data cache simulator, whereafter at step 605 a lookup procedure is performed in the tag RAM of the cache simulator in order to determine whether the address is found in that tag RAM. If not, then a cache miss has occurred and accordingly a line of data is loaded from memory, that line of data including data at the address the subject of the write access request. Thereafter that line of data is written into the cache simulator at step 615. Following step 615, or directly following step 605 in the event of a cache hit, the data value the subject of the write access request is updated in the cache simulator at step 620.

In addition, the checker 105 will include a monitoring function which, in response to the write access request, will also update at step 625 the data value in master memory 110. This monitoring function can be considered to be incorporated as part of the first and second checking routines 200, 210 of FIG. 2.

It will be appreciated that when performing a write access request such as described with reference to FIG. 6, there is no need for any comparison to be performed with respect to master memory, since part of the writing process involves the update of the master memory.

It should be noted that FIG. 6 illustrates the process performed for an “allocate on write” cache. If the cache were instead arranged as an “allocate on read” cache, then in the event of a cache miss steps 610 and 615 would not be performed, and instead the updated data value would merely be output to memory at step 620 rather than being stored in the cache.

From the above description of an embodiment of the present invention, it will be appreciated that the test system of embodiments of the present invention maintains a separate master image of physical memory which is maintained by the test model and in particular is updated instantly on any write operation, bypassing any write buffers, caches, etc that may be being modelled by the test system. Whenever hits occur in cache simulators and TLB simulators, the master image is checked to verify that correct data is being returned. If there is a discrepancy, the model can alert the user, for example by creating an entry in a discrepancy log. This process is found to be extremely useful when developing and verifying certain pieces of software, for example operating system software, since an operating system must maintain the caches and TLBs, cleaning and/or invalidating entries when necessary. If the operating system is not performing these functions correctly, it can be difficult to track down the source of the resulting errors, but the test system of embodiments of the present invention significantly eases this task through the identification and logging of the sources of such errors as they occur.

The above techniques may be used in test systems used to model a data processing apparatus having only a single processor. In addition, the same techniques can be used to test software intended for use in a data processing apparatus having multiple processors, for example in an SMP system, where multiple CPUs may have to co-operate to make sure all stale data is flushed from caches and TLBs.

Although a particular embodiment of the invention has been described herein, it will be apparent that the invention is not limited thereto, and that many modifications and additions may be made within the scope of the invention. For example, various combinations of the features of the following dependent claims could be made with the features of the independent claims without departing from the scope of the present invention.

I claim:

1. A test system for testing software to be run on a data processing apparatus having a processor operable to perform data processing operations, a memory operable to store data for access by the processor, and at least one temporary storage located between the processor and the memory and operable to temporarily store data to improve speed of access to that data by the processor, the software being operable to control the maintenance of data by the at least one temporary storage, the test system comprising:
a processor simulator operable to simulate the data processing operations performed by the processor, the processor simulator being operable to issue an access request when access to a data value is required, the access request causing one or more data access operations to be performed;
a temporary storage simulator provided for each temporary storage and operable to simulate the operation of that associated temporary storage, each data access operation of the access request being routed to an appropriate temporary storage simulator, and that temporary storage simulator being operable in response to the data access operation to determine whether data required by that data access operation is stored in the temporary storage simulator, and if so to cause that data to be retrieved from the temporary storage simulator rather than from the memory; and
a checker operable to perform a checking operation to check the accuracy of the data retrieved for each data access operation of the access request.

2. A test system as claimed in claim 1, further comprising:
a reference image of the memory; and
a monitor operable, when the processor simulator outputs a write access request containing an updated data value, to cause that updated data value to be directly stored in the reference image, such that the reference image contains an up-to-date version of the data accessible by the processor simulator;
the checker being operable to refer to the reference image of the memory when performing the checking operation.

3. A test system as claimed in claim 2, wherein each data access operation specifies an address, and the checker is operable to determine whether the data retrieved for that data access operation corresponds to the data as stored at that address in the reference image of the memory, and if not to generate discrepancy data.

4. A test system as claimed in claim 3, further comprising a log into which any discrepancy data generated by the checker is stored.

5. A test system as claimed in claim 1, wherein the temporary storage simulator is operable to simulate the operation of a data cache and is arranged to receive a data access operation performed for any access request issued by the processor simulator and pertaining to data processed by the processor simulator.

6. A test system as claimed in claim 2, wherein the temporary storage simulator is operable to simulate the operation of a data cache and is arranged to receive a data access operation performed for any access request issued by the processor simulator and pertaining to data processed by the processor simulator, if that access request is said write access request, the monitor being operable to cause the updated data value to be stored in the reference image of the memory without waiting for the updated data value to be stored in the memory.

7. A test system as claimed in claim 1, wherein the temporary storage simulator is operable to simulate the operation of an instruction cache and is arranged to receive a data access operation performed for any read access request issued by the processor simulator and pertaining to an instruction required for execution by the processor simulator.

8. A test system as claimed in claim 1, wherein the temporary storage simulator is operable to simulate the operation of a translation lookaside buffer of a memory management unit, and is arranged to receive a data access operation specifying the virtual address of each access request issued by the processor simulator and to determine whether data required to generate a physical address from that virtual address is stored within the temporary storage simulator.

9. A test system as claimed in 2, wherein:
the temporary storage simulator is operable to simulate the operation of a translation lookaside buffer of a memory management unit, and is arranged to receive a data access operation specifying the virtual address of each access request issued by the processor simulator and to determine whether data required to generate a physical address from that virtual address is stored within the temporary storage simulator;
the data required to generate a physical address is located in a page table stored in the memory, and is retrievable from the memory into the translation lookaside buffer if necessary to enable the physical address to be generated by the memory management unit; and
the checker is operable to compare the physical address generated by the memory management unit with the physical address that would have been generated from the page table data stored in the reference image of the memory.

10. A test system as claimed in claim 1, wherein the data processing apparatus has a plurality of processors, each processor having at least one temporary storage associated therewith, the test system comprising:
one of said processor simulators for each of said plurality of processors; and
for each processor simulator, a temporary storage simulator provided for each temporary storage associated with the corresponding processor.

11. A test system as claimed in claim 1, wherein the software is operating system software.

12. A method of testing software to be run on a data processing apparatus having a processor for performing data processing operations, a memory for storing data for access by the processor, and at least one temporary storage located between the processor and the memory for temporarily storing data to improve speed of access to that data by the processor, the software being operable to control the maintenance of data by the at least one temporary storage, the method comprising the steps of:
simulating the data processing operations performed by the processor, including issuing an access request when access to a data value is required, the access request causing one or more data access operations to be performed;
simulating the operation of each temporary storage using an associated temporary storage simulator;
providing each data access operation of the access request to an appropriate temporary storage simulator;
in response to receipt of one of said data access operations by said appropriate temporary storage simulator, determining whether data required by that data access operation is stored in that temporary storage simulator, and if so retrieving that data from the temporary storage simulator rather than from the memory; and
performing a checking operation to check the accuracy of the data retrieved for each data access operation of the access request.

13. A computer program product carrying a computer program which when executed on a computer implements a method of testing software to be run on a data processing apparatus having a processor for performing data processing operations, a memory for storing data for access by the processor, and at least one temporary storage located between the processor and the memory for temporarily storing data to improve speed of access to that data by the processor, the software being operable to control the maintenance of data by the at least one temporary storage, the computer program implementing the steps of:
simulating the data processing operations performed by the processor, including issuing an access request when access to a data value is required, the access request causing one or more data access operations to be performed;
simulating the operation of each temporary storage using an associated temporary storage simulator;
providing each data access operation of the access request to an appropriate temporary storage simulator;
in response to receipt of one of said data access operations by said appropriate temporary storage simulator, determining whether data required by that data access operation is stored in that temporary storage simulator, and if so retrieving that data from the temporary storage simulator rather than from the memory; and
performing a checking operation to check the accuracy of the data retrieved for each data access operation of the access request.

14. A test system for testing software to be run on a data processing apparatus having a processor for performing data processing operations, a memory for storing data for access by the processor, and at least one temporary storage located between the processor and the memory for temporarily storing data to improve speed of access to that data by the processor, the software being operable to control the maintenance of data by the at least one temporary storage, the test system comprising:
processor simulator means for simulating the data processing operations performed by the processor, the processor simulator means being arranged to issue an access request when access to a data value is required, the access request causing one or more data access operations to be performed;
temporary storage simulator means provided for each temporary storage and for simulating the operation of that associated temporary storage, each data access operation of the access request being routed to an appropriate temporary storage simulator means, and that temporary storage simulator means being responsive to the data access operation to determine whether data required by that data access operation is stored in the temporary storage simulator means, and if so to cause that data to be retrieved from the temporary storage simulator means rather than from the memory; and
checker means for performing a checking operation to check the accuracy of the data retrieved for each data access operation of the access request.
